(19) United States
(12) Patent Application Publication
(10) Pub. No.: US 2020/0090023 A1
(43) Pub. Date: Mar. 19, 2020

(54) SYSTEM AND METHOD FOR CASCADED MAX POOLING IN NEURAL NETWORKS

(71) Applicant: Huawei Technologies Co., Ltd., Shenzhen (CN)

(72) Inventors: John Joseph, Shenzhen (CN); Serdar Sozubek, North York (CA)

(21) Appl. No.: 16/131,780

(22) Filed: Sep. 14, 2018

(51) Int. Cl. G06N 3/04; G06N 3/063

(52) U.S. Cl. CPC G06N 3/04; G06N 3/08; G06N 3/063

(57) ABSTRACT

A method for performing size K×K max pooling with stride S at a pooling layer of a convolutional neural network to downsample input data includes receiving input data, buffering the input data, applying a cascade of size 2×2 pooling stages to the buffered input data to generate downsampled output data, and outputting the downsampled output data to another layer of the convolutional neural network for further processing.

### TECHNICAL FIELD

The present disclosure relates generally to a system and method for data processing, and, in particular embodiments, to a system and method for cascaded max pooling in neural networks.

### BACKGROUND

Neural networks (NNs) are computing systems that are inspired by how biological brains operate. NNs can learn to perform tasks, such as object detection, image recognition, voice recognition, or pattern recognition, by considering examples. NNs typically do not need to be programmed with any task-specific rules. Instead, NNs learn identifying characteristics from the examples they process.

Convolutional neural networks (CNNs) are a sub-class of feed forward NNs that have distinct logical representations of computational layers optimized for tasks such as image classification. When used for image classification, CNNs can learn to identify features of an image, such as visual objects. The learning step is formally known as training where a given neural network is input a reference input dataset comprising input data representative of images which are known to contain some desired visual objects of interest. Once training is complete, a NN can be deployed to detect visual objects of interest from images input to the trained CNN. This phase formerly referred to as inference.

CNNs may have significant resource (e.g., compute resources and memory resources) requirements, especially during training. Therefore, there is a need for a system and method for reducing resource requirements in NNs, and particularly, CNNs.

### SUMMARY

Example embodiments provide a system and method for cascade max pooling in neural networks.

In accordance with an aspect of the present disclosure, a computer-implemented method is provided for performing size K×K max pooling with stride S at a pooling layer of a convolutional neural network to downsample input data. The computer-implemented method includes receiving, at the max pooling layer, input data, buffering, at the max pooling layer, the input data, applying, at the max pooling layer, a cascade of size 2×2 pooling stages to the buffered input data to generate downsampled output data, and outputting, from the max pooling layer, the downsampled output data to another layer of the convolutional neural network for further processing.

Optionally, in any of the preceding aspects, a first subset of the size 2×2 pooling stages are with stride 1 and a second subset of the size 2×2 pooling stages are with stride S.

Optionally, in any of the preceding aspects, the first subset comprises K−2 size 2×2 pooling with stride 1 stages and the second subset comprises one dimension 2 with stride S pooling stage.

Optionally, in any of the preceding aspects, applying the cascade of size 2×2 pooling stages includes applying, at the max pooling layer, a cascade of K−2 size 2×2 pooling with stride 1 stages to the buffered input data to generate intermediate output data, and applying, at the max pooling layer, a size 2×2 pooling with stride S stage to the intermediate output data to generate the downsampled output data.

Optionally, in any of the preceding aspects, the cascade of K−2 size 2×2 pooling with stride 1 stages is applied to the buffered input data prior to the applying of the size 2×2 pooling with stride S stage.

Optionally, in any of the preceding aspects, the cascade of size 2×2 pooling stages comprises a linear sequence of size 2×2 pooling stages.

Optionally, in any of the preceding aspects, the convolutional neural network is part of a graphics processing unit (GPU).

In accordance with another aspect of the present disclosure, a processing unit is provided. The processing unit includes a first comparator operatively coupled to the data input and a delayed data input, the first comparator configured to output a greater of the data input or the delayed data input, a data buffer operatively coupled to an output line of the first comparator and a stride input, the data buffer configured to store an output of the first comparator, a second comparator operatively coupled to an output line of the data buffer and the output line of the first comparator, the second comparator configured to output a greater of the output of the first comparator or an output of the data buffer, a mask buffer operatively coupled to the output line of the first comparator, the mask buffer configured to remove unwanted values, a multiplexer operatively coupled to the output line of the mask buffer, to the output line of the first comparator, and to an output line of the second comparator, the multiplexer configured to select between an output of the mask buffer or the output of the first comparator in accordance with an output of the second comparator, and a controller in communication with the data buffer, the controller configured to receive a stride value, control the data buffer to buffer the output of the first comparator in accordance with the stride value, and output the buffered output of the first comparator in accordance with the stride value.

Optionally, in any of the preceding aspects, computer-implemented method further includes a delay element operatively coupled to the data input and the first comparator, the delay element configured to output the delayed data input.

Optionally, in any of the preceding aspects, the first comparator and the second comparators are two-input and one-output comparators.

Optionally, in any of the preceding aspects, the device realizes a size K×K max pooling with stride S kernel as a cascade of K−1 size 2×2 max pooling stages, and wherein a size of the data buffer is expressible as

[(2N−K+1)(K−2)/2]+[((N−K)/S)+1],

where K is a size of the size K×K max pooling with stride S kernel in either dimension, S is a stride of the size K×K max pooling with stride S kernel, and N is a size of the input data.

Optionally, in any of the preceding aspects, the processing unit is a size 2×2 max pooling unit.

Optionally, in any of the preceding embodiments, an embodiment wherein the processing unit implements a max pooling layer in a convolutional neural network (CNN).

In accordance with another aspect of the present disclosure, a device is provided. The device includes a central processing unit configured to execute instructions stored in a memory storage, and a processing unit operatively coupled to the central processing unit, the memory storage, and a data input. The processing unit is configured to perform size K×K max pooling with stride S at a max pooling layer of a convolutional neural network to downsample input data received at the data input, wherein the processing unit performs the size K×K max pooling with stride S as a cascade of K−1 size 2×2 max pooling stages, where K and S are integer values.

Optionally, in any of the preceding aspects, the processing unit includes a first comparator operatively coupled to a data input and a delayed data input, the first comparator configured to output a greater of the data input or the delayed data input, a data buffer operatively coupled to an output line of the first comparator and a stride input, the data buffer configured to store an output of the first comparator, a second comparator operatively coupled to an output line of the data buffer and the output line of the first comparator, the second comparator configured to output a greater of the output of the first comparator or an output of the data buffer, a mask buffer operatively coupled to the output line of the first comparator, the mask buffer configured to remove unwanted values, a multiplexer operatively coupled to the output line of the mask buffer, to the output line of the first comparator, and to an output line of the second comparator, the multiplexer configured to select between an output of the mask buffer or the output of the first comparator in accordance with an output of the second comparator, and a controller in communication with the data buffer, the controller configured to receive a stride value, control the data buffer to buffer the output of the first comparator in accordance with the stride value, and output the buffered output of the first comparator in accordance with the stride value.

Optionally, in any of the preceding aspects, the processing unit further includes a delay element operatively coupled to the data input and the first comparator, the delay element configured to output the delayed data input.

Optionally, in any of the preceding aspects, the first comparator and the second comparators are two-input and one-output comparators.

Optionally, in any of the preceding aspects, a size of the data buffer is expressible as

[(2N−K+1)(K−2)/2]+[((N−K)/S)+1],

where K is a size of the size K×K max pooling with stride S kernel in either dimension, S is a stride of the size K×K max pooling with stride S kernel, and N is a size of the input data.

Optionally, in any of the preceding aspects, the data input is operatively coupled to a digital camera.

Optionally, in any of the preceding aspects, the device is a user equipment (UE).

Practice of the foregoing embodiments enables a reduction in resource requirements in a neural network by implementing a size N×N and stride S max pooling layer as a cascade of 2×2 max pooling layers. The use of small size max pooling layers reduces the computational and memory resources required when compared with large size max pooling layers.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a diagram of an example CNN;

FIG. 2 illustrates a diagram highlighting an example max pooling operation performed by a pooling layer of a CNN;

FIG. 3 illustrates an example arrangement of image data and an ordering of data elements at a max pooling layer;

FIG. 4 illustrates an example data buffer supporting N×N input data with a size K×K max pooling kernel;

FIG. 5 illustrates an example reduction tree of comparators;

FIG. 6 illustrates a diagram demonstrating a determining of a maximum of a size 3×3 data window of input data using a size 2×2 max pooling kernel;

FIG. 7 illustrates the partitioning of a size K×K max pooling with stride S kernel into a cascade of K−1 size 2×2 max pooling stages;

FIG. 8 illustrates a diagram of the correspondence between two-dimensional max pooling and one-dimensional max pooling according to example embodiments described herein;

FIG. 9 illustrates a diagram of the application of a size 5 max pooling with stride 2 kernel realized as a cascade of size 2 max pooling stages to a size 9 input data according to example embodiments described herein;

FIG. 10 illustrates a diagram of the application of a size 6 max pooling with stride 6 kernel realized as a cascade of size 2 max pooling stages to a size 12 input data according to example embodiments described herein;

FIG. 11 illustrates a hardware implementation of a size 2×2 max pooling stage according to example embodiments described herein;

FIG. 12 illustrates a flow diagram of example operations occurring in a max pooling layer according to example embodiments described herein; and

FIG. 13 is a block diagram of a computing system that may be used for implementing the devices and methods disclosed herein.

### DETAILED DESCRIPTION OF ILLUSTRATIVE EMBODIMENTS

The making and using of the disclosed embodiments are discussed in detail below. It should be appreciated, however, that the present disclosure provides many applicable inventive concepts that can be embodied in a wide variety of specific contexts. The specific embodiments discussed are merely illustrative of specific ways to make and use the embodiments, and do not limit the scope of the disclosure.

As discussed previously, convolutional neural networks (CNNs) are a sub-class of feed forward neural networks (NNs) that have a distinct logical representation of computational layers optimized for tasks such as image classification. A CNN may learn to identify features of an image through training where the CNN is provided a controlled reference input dataset that is known to include data representative of some images that contain visual objects of interest. Once training is complete, the CNN begins an inference phase, where the CNN may be deployed to detect visual objects of interest from images input to the trained CNN. Overall, CNNs may require significant compute and memory resources, especially during training.

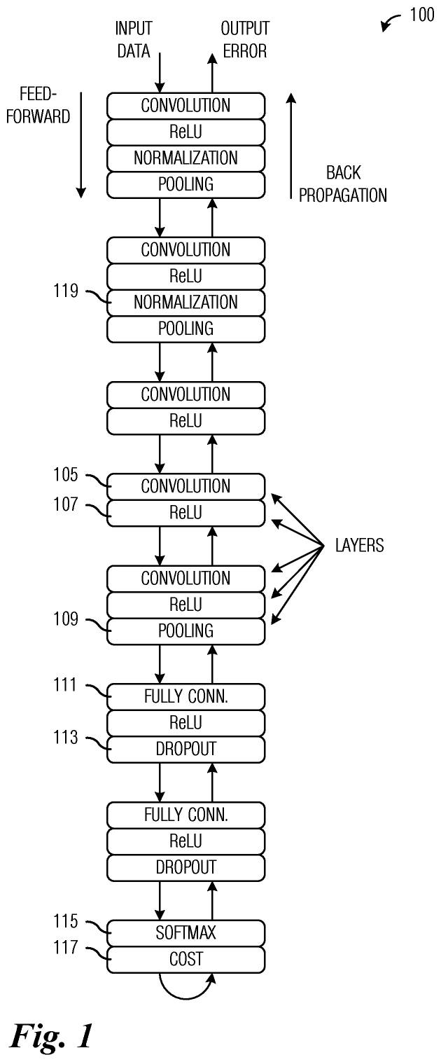

FIG. 1 illustrates a diagram of an example CNN 100. Each CNN comprises several layers that are combined together and represented logically as a network of compute elements. As shown in FIG. 1, CNN 100 includes layers, including a convolution layer (such as convolution layer 105), a rectified linear unit (ReLU) layer (such as ReLU layer 107) that applies an activation function to the data, a pooling layer (such as pooling layer 109) that downsamples the data, a fully connected layer (such as fully connected layer iii), a dropout layer (such as dropout layer 113) that activates or deactivates neurons, a softmax layer (such as softmax layer 115) that implements a loss function, a cost layer (such as cost layer 117) that implements a cost function for the neurons, and a normalization layer (such as normalization layer 119) that adjusts neuron responses. CNN 100, and the arrangement of the layers and the flow of the data therein, is presented as an example for discussion purposes. Therefore, CNN 100 is not intended to be limiting to the scope or the spirit of the example embodiments.

The pooling layer is a data processing layer of a CNN and may appear multiple times in the CNN. The pooling layer downsamples or spatially shrinks its input. The pooling layer reduces memory and compute requirements of subsequent layers. The pooling layer partitions its input data into windows and determines a single value from the values in each window. Different schemes may be implemented at a pooling layer, including:

Max pooling—the maximum value from the values in a window is selected as the single value;

Average pooling—an average of the values in a window is determined as the single value; and

Weighted average pooling—a weighted average of the values in a window is determined as the single value.

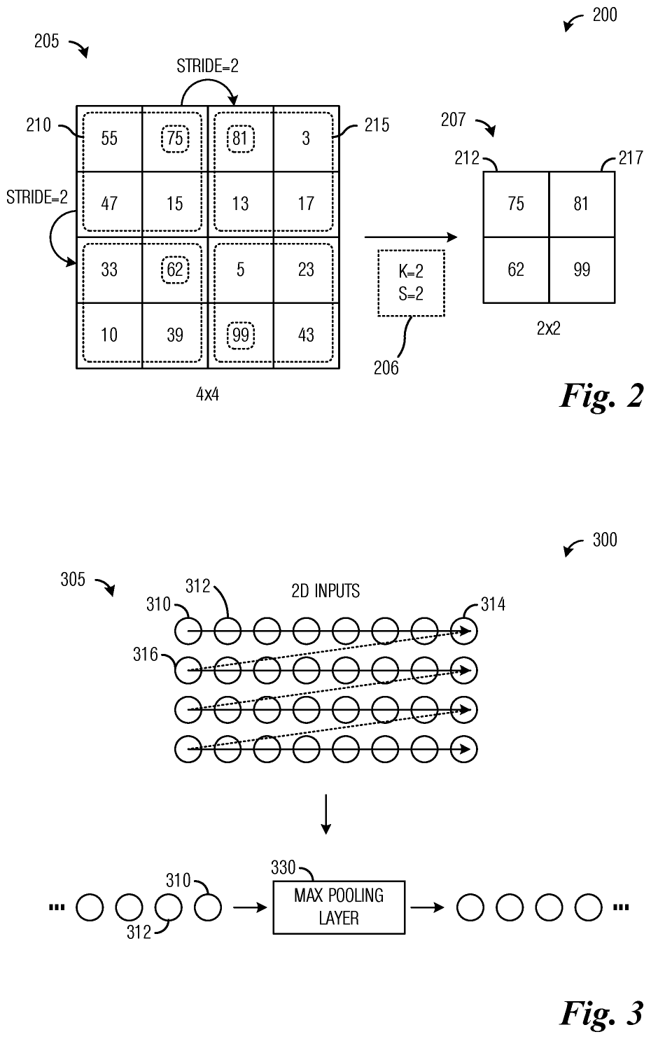

FIG. 2 illustrates a diagram 200 highlighting an example max pooling operation. As shown in FIG. 2, a 4×4 matrix 205 is input to a size 2×2 with stride 2 max pooling layer 206, which is hereinafter referred to as max pooling layer 206. The size of a max pooling layer specifies the size of the windows of the input data, while the stride specifies an offset position where a next window of the input data begins. Output of max pooling layer 206 is a 2×2 matrix 207. Because max pooling layer 206 has size 2×2, each individual windows of input data processed by max pooling layer 206 is a 2×2 sub-matrix. In the example shown in FIG. 2, the input data (e.g., the 4×4 matrix 205) is partitioned into windows 210, 215, 220, 225, where each window is a 2×2 sub-matrix 5. As discussed previously, a max pooling layer will select the maximum value from the values of each window and output the single value. As an example, for window 210, the maximum value is 75, for window 215, the maximum value is 81, for window 220, the maximum value is 62, and for window 225, the maximum value is 99. Matrix 207 contains the single value outputs for each of the individual windows. As an example, element 212 holds value 75, which corresponds to the maximum value for window 210, element 217 holds value 81, which corresponds to the maximum value for window 215, element 219 holds value 62, which corresponds to the maximum value for window 220, and element 221 holds value 99, which corresponds to the maximum value for window 225.

The partitioning of the input data may be described as follows:

Start from the top left corner of the input data matrix and form a sub-matrix of the same size as the size of the max pooling stage which is commonly referred to as a pooling kernel. Find the maximum value in the sub-matrix. The maximum value is the single value representing the particular sub-matrix.

Move to the right by the stride amount and form another sub-matrix of the same size as the pooling kernel. Find the maximum value in the sub-matrix. The maximum value is the single value representing the particular sub-matrix.

Repeat until the end of the input data in the horizontal direction is reached.

Move back to the left side of the input data matrix. Move down by the stride amount and form another sub-matrix with the same size as the pooling kernel. Find the maximum value in the sub-matrix. The maximum value is the single value representing the particular sub-matrix.

Repeat moving to the right and down until all data from the input data matrix is covered.

In hardware device architectures, in many situations it is optimal to implement a streaming architecture. A streaming architecture refers to a data execution model where compute operations can be fully pipelined so that in optimal conditions for every clock cycle of execution, a result is produced. In general, this is optimal for systems in which an input stream of data can be provided to the hardware to sustain the pipelined execution. In the case of image processing, graphic processors implement architectures to concurrently buffer input images while executing compute units.

FIG. 3 illustrates an example arrangement 300 of image data and an ordering of data elements at a max pooling layer. When processing image data in a CNN, the order of the data elements as they arrive at a max pooling layer is also a concern. Image data is typically organized into two-dimensional arrays of pixels, where each pixel is associated with a Cartesian coordinate of where the image appears on a display. As shown in FIG. 3, image data is arranged in a two-dimensional array 305. Furthermore, when performing max pooling (or other forms of image processing) image data is provided in raster-order, where the first data element to arrive is the element from the first row and first column of the two-dimensional array, followed by data elements to its right and then starting again at the left most data element of the second row, etc. As an example, a first data element 310 of two-dimensional array 305 is the first to arrive at a max pooling layer, followed by a second data element 312, and so on. A last data element 314 of the first row is followed by the first data element 316 of the second row, etc.

In a streaming architecture implementation of a max pooling layer, compute operations should be fully pipelined in order to achieve maximum compute performance. If the image data arrives in raster order, then some execution clock cycles are spent loading data elements into memory until a full max pooling window is available, which negatively impacts performance and increases memory requirements. This is a problem to be addressed in the streaming architecture of the max pooling layer.

A typical streaming architecture implementation of a max pooling layer includes:

A buffer to store data for overlapping windows provided to the max pooling layer; and

A plurality of comparators to compute the maximum value.

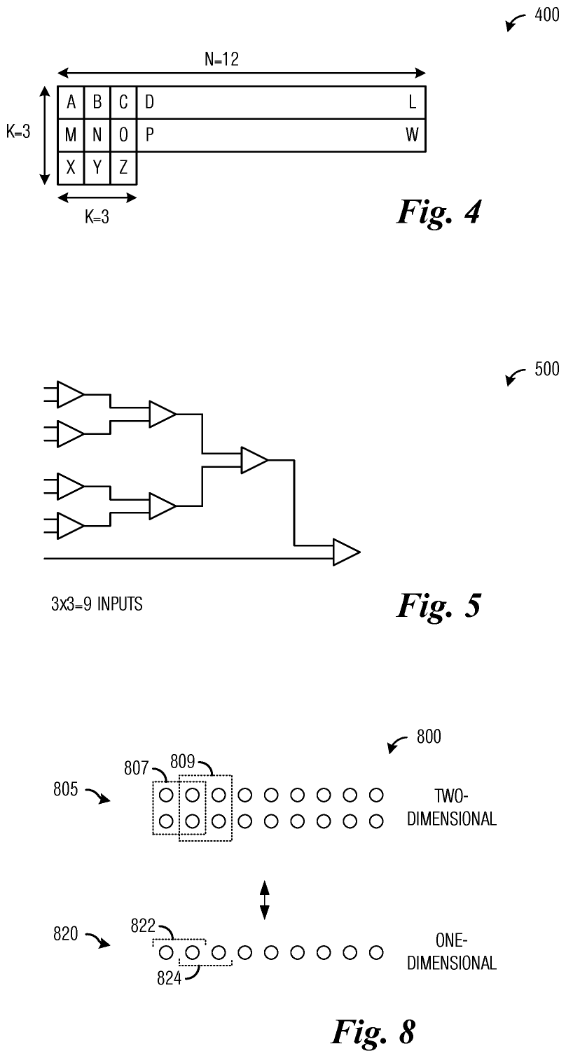

FIG. 4 illustrates an example data buffer 400 supporting N×N input data with a size K×K max pooling kernel. For N×N input data with a size K×K max pooling kernel, a minimum size of a data buffer for streaming input data arriving in raster-scan order is expressible as:

Buffer_size=N(K−1)+K.

As shown in FIG. 4, data buffer 400 supports 12×12 input data with a size 3×3 max pooling kernel.

In order to support pipelined computation of the maximum value of an individual window, a reduction tree of comparators may be used. FIG. 5 illustrates an example reduction tree of comparators 500. Reduction tree of comparators 500 comprises a plurality of two-input comparators. A number of two-input comparators of a reduction tree of comparators supporting the computation of the maximum value of a window of input data with size K×K is expressible as:

Comparators_required=K*K−1.

As shown in FIG. 5, reduction tree of comparators 500 comprises 8 two-input comparators and supports the computation of the maximum value of a window of data with size 3×3.

As shown above, the amount of buffer storage and the number of comparators grow as a function of:

Size of the max pooling kernel. The buffer storage and number of comparators grow in proportion to the size of the max pooling kernel for a fully parallel max pooling implementation. The buffer storage and number of comparators growth is compounded if the input data is multi-channeled. As an example, a typical image file has multiple channels for different colors (such as Red-Green-Blue), and max pooling is to be performed on each channel.

Number of max pooling layers in a particular CNN implementation. A CNN may have multiple max pooling layers.

As an example of the buffer storage and comparator needs of a streaming performance CNN, an example CNN with three max pooling layers is considered. The example CNN includes a first max pooling layer that supports size 3×3 max pooling with stride 2 on 96 channels, a second max pooling layer that supports size 3×3 max pooling with stride 2 on 256 channels, and a third max pooling layer that supports size 3×3 max pooling with stride 2 on 256 channels. In order to achieve streaming performance, a total of 96+256+256=608 instances of max pooling logic is needed to implement the example CNN directly in fully pipelined hardware.

In addition to the substantial hardware requirements, an attempt to map the computations of the example CNN onto smaller footprint devices, such as mobile handsets, user equipments (UEs), digital cameras, etc., would require more resources than typically available on these smaller footprint devices.

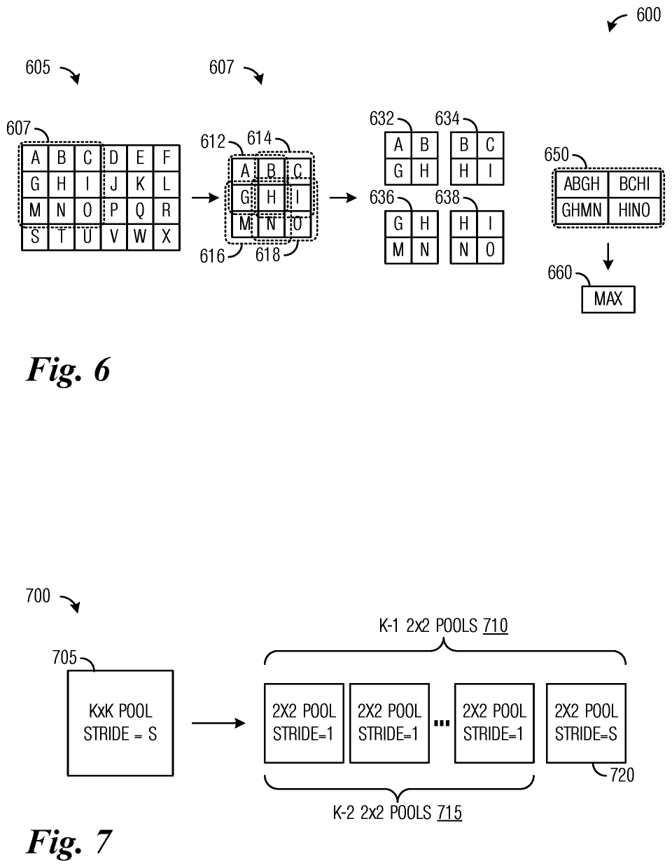

It is possible to determine a maximum of a large window using a max pooling kernel with a size that is smaller than the size of the large window. FIG. 6 illustrates a diagram 600 demonstrating a determining of a maximum of a size 3×3 window using a size 2×2 max pooling kernel. As shown in FIG. 6, input data 605 is a size 6×4 matrix of data values and it is desired to determine a maximum value in a size 3×3 window 607 of input data 605. As an example, the maximum value of input data 605 may be determined by determine the maximum value in individual 3×3 sized windows spanning the entirety of input data 605.

In order to determine the maximum value of size 3×3 window 607 using a size 2×2 max pooling kernel, size 3×3 tile 607 is partitioned into size 2×2 windows 612, 614, 616, and 618. There is some overlap in the size 2×2 windows that is due to the size difference between size 3×3 window 607 and the size 2×2 max pooling kernel. Size 2×2 matrices 632, 634, 636, and 638 display the data in size 2×2 windows 612, 614, 616, and 618. A maximum value of each size 2×2 window is determined using the size 2×2 max pooling kernel. A size 2×2 window 650 displays the output of the size 2×2 max pooling kernel after the size 2×2 max pooling kernel is applied to size 2×2 windows 612, 614, 616, and 618. Size 2×2 window 650 is then provided to the size 2×2 max pooling kernel to determine a maximum value 660 of size 2×2 window 650, which is also the maximum value of size 3×3 window 607.

According to an example embodiment, any size K×K max pooling with stride S kernel may be partitioned into a cascade of size 2×2 max pooling stages. The output produced by the first max pooling stage (and intermediate max pooling stages) in the cascade of size 2×2 max pooling stages becomes input for next max pooling stage, with exception of the last max pooling stage in the cascade of size 2×2 max pooling stages. The output of the last max pooling stage is the output of the original size K×K max pooling with stride S kernel. The partitioning of the size K×K max pooling with stride S kernel allows for the development of a general hardware circuit to perform the maximum value comparison on size 2×2 windows. Additionally, the cascade of size 2×2 max pooling stages allows the max pooling operations to be performed on the general hardware circuit and executed sequentially (on a max pooling stage by stage basis) in a fully pipelined manner for each max pooling layer of a CNN. Furthermore, the general hardware circuit may be developed into a hardware circuit for the max pooling operation that meets design constraints such power consumption, silicon area, and so on.

According to an example embodiment, a size K×K max pooling with stride S kernel is implemented using a cascade of K−1 stages of size 2×2 max pooling kernels. In an embodiment, a first K−2 stages out of the K−1 total stages are stride 1 max pooling stages and a last max pooling stage is a stride S max pooling stage. Each stage of the cascade (except for the last stage of the cascade) applies max pooling operations to the entirety of its input data, with the output of one stage becoming the input of a subsequent stage. The last stage of the cascade applies the max pooling operations to the entirety of its input data, with the output being the output of the size K×K max pooling with stride S kernel.

FIG. 7 illustrates the partitioning 700 of a size K×K max pooling with stride S kernel into a cascade of K−1 size 2×2 max pooling stages. As shown in FIG. 7, a size K×K max pooling with stride S kernel 705 is partitioned into a cascade of K−1 size 2×2 max pooling stages 710. The size 2×2 max pooling stages of cascade of K−1 size 2×2 max pooling stages 710 are arranged in a linear sequence, with the output of one stage being the input to the next stage. Cascade of K−1 size 2×2 max pooling stages 710 comprises K−2 size 2×2 max pooling with stride 1 stages 715 and one size 2×2 max pooling with stride S stage 720. As an example, a size 5×2 max pooling with stride 2 kernel is realized as a cascade of 4 size 2×2 max pooling stages, where 3 stages are size 2×2 max pooling with stride 1 stages and 1 stage is a size 2×2 max pooling with stride 2 stage.

Cascaded max pooling achieves the same result of a size K×K max pooling with stride S kernel by applying a cascade of size 2×2 max pooling stages to the input data. During this process, output of one size 2×2 max pooling stage becomes the input of the subsequent size 2×2 max pooling stage. It is important to ensure that the values in different K×K windows do not get mixed with each other at any stage of the cascaded size 2×2 max pooling stages. Otherwise it is possible to take the maximum of some values which would not have been compared in the first place had the original size K×K max pooling kernel been applied. In the examples that follow, values in each window of input data of the cascaded size 2×2 max pooling stage are analyzed to ensure that right comparisons are made. To simplify the figures, examples that follow are given with one-dimensional max pooling instead of two-dimensional max pooling. For the purpose of this discussion, one-dimensional max pooling and two-dimensional max pooling produce similar results.

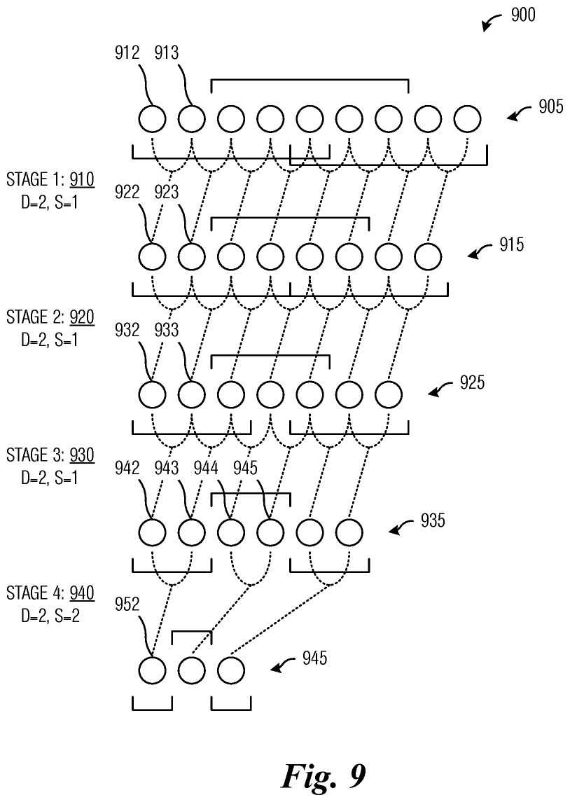

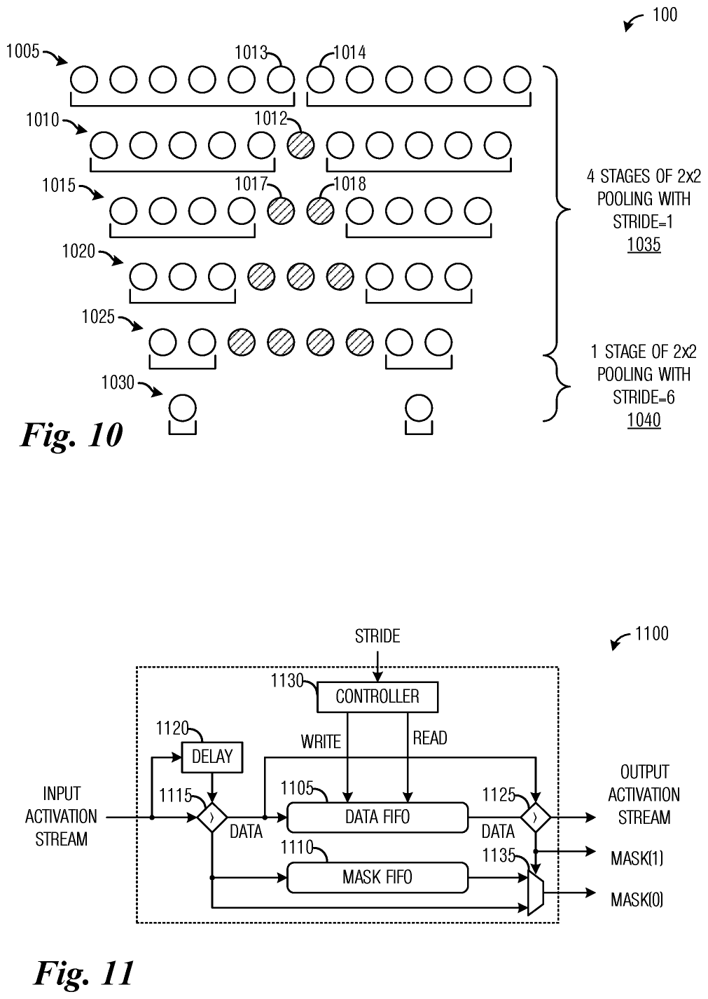

FIG. 8 illustrates a diagram 800 of the correspondence between two-dimensional max pooling and one-dimensional max pooling. As shown in FIG. 8 (and also in FIG. 9 and FIG. 10), the windows of values in one-dimensional max pooling indicate the values for which the maximum should be calculated. These windows of values in one dimension correspond to the windows of values in two dimensions. A first sequence of data values 805 represents two-dimensional data, such as image data. First sequence of data values 805 comprises a 2×9 array, but the example embodiments presented herein are operable with arrays of other dimensions. A size 2×2 max pooling with stride 1 kernel is applied to first sequence of data values 805. In a first application of the size 2×2 max pooling with stride 1 kernel, data values in tile 807 are processed, and in a second application of the size 2×2 max pooling with stride 1 kernel, data values in tile 809 are processed, and so on. A second sequence of data values 820 represents one-dimensional data, such as image data. Second sequence of data values 820 comprises a 1×9 array, but the example embodiments presented herein are operable with arrays of other dimensions. A size 2 max pooling with stride 1 kernel is applied to second sequence of data values 820. In a first application of the size 2 max pooling with stride 1 kernel, data values in window 822 are processed, and in a second application of the size 3 max pooling with stride 1 kernel, data values in window 824 are processed.

The application of the max pooling kernel shown in FIG. 8 occurs in the horizontal direction. However, the application of the max pooling kernel in the vertical direction is also similar. Therefore, it is possible to simplify the illustration of the application of the max pooling kernel by showing the process in one dimension.

FIG. 9 illustrates a diagram 900 of the application of a size 5 max pooling with stride 2 kernel realized as a cascade of size 2 max pooling stages to a size 9 input data. The max pooling shown in FIG. 9 is one-dimensional max pooling and is presented as an analog to two-dimensional max pooling in order to simplify the figure. The example embodiments presented herein are operable with one-dimensional or two-dimensional max pooling. The presentation of one-dimensional max pooling is not intended to be limiting to either the scope or spirit of the example embodiments. The size 5 max pooling with stride 2 kernel is realized as a cascade of 4 size 2 max pooling stages. The size 9 input data is shown as a sequence 905. In a first max pooling stage, a size 2 max pooling with stride 1 kernel is applied to the input data in sequence 905. Because the stride is equal to 1, adjacent data values are compared, with a hop of one between consecutive comparisons. As an example, input data 912 is compared with input data 913 to produce output data 922. Output of the first max pooling stage is shown as a sequence 915 comprising 8 data values. In a second max pooling stage, a size 2 max pooling with stride 1 kernel is applied to the input data in sequence 915. Because the stride is equal to 1, adjacent data values are compared, with a hop of one between consecutive comparisons. As an example, input data 922 is compared with input data 923 to produce output data 932. Output of the second max pooling stage is shown as a sequence 925 comprising 7 data values.

In a third max pooling stage, a size 2 max pooling with stride 1 kernel is applied to the input data in sequence 925. Because the stride is equal to 1, adjacent data values are compared, with a hop of one between consecutive comparisons. As an example, input data 932 is compared with input data 933 to produce output data 942. Output of the third max pooling stage is shown as a sequence 935 comprising 6 data values. In a fourth max pooling stage, a size 2 max pooling with stride 2 kernel is applied to the input data in sequence 935. Because the stride is equal to 2, adjacent data values are compared, with a hop of two between consecutive comparisons. As an example, input data 942 is compared with input data 943 to produce output data 952. However, a consecutive comparison compares input data 944 with input data 945. Output of the fourth max pooling stage is shown as a sequence 945 comprising 3 data values. The size 5 max pooling with stride 2 is complete, with sequence 945 being its output data.

FIG. 10 illustrates a diagram 1000 of the application of a size 6 max pooling with stride 6 kernel realized as a cascade of size 2 max pooling stages to a size 12 input data. The max pooling shown in FIG. 10 is one-dimensional max pooling and is presented as an analog to two-dimensional max pooling in order to simplify the figure. The example embodiments presented herein are operable with one-dimensional or two-dimensional max pooling. The presentation of one-dimensional max pooling is not intended to be limiting to either the scope or spirit of the example embodiments. The size 6 max pooling with stride 6 kernel is realized as a cascade of 5 size 2 max pooling stages. The size 12×12 input data is shown as a sequence 1005 comprising 12 data values. In a first max pooling stage, a size 2 max pooling with stride 1 kernel is applied to the input data in sequence 1005, producing a sequence 1010 as output. Sequence 1010 comprises a total of ii data values. However, because the original stride of the max pooling kernel is greater than 2 (the original stride is equal to 6), junk values such as junk values 1012, 1017, 1018 and other shaded nodes are produced. A junk value is produced when the size 2 max pooling kernel processes data values that span adjacent windows. In other words, a junk value is produced with a comparison made by the size 2 max pooling kernel compares data values that span adjacent windows. A junk value is, in general, an unwanted value. As an example, junk value 1012 is produced when the size 2 max pooling kernel processes data value 1013 and data value 1014 that are located in different data windows. A junk value may also be produced when the size 2 max pooling kernel processes a data value and a junk value, or two junk values.

In a second max pooling stage, a size 2 max pooling with stride 1 kernel is applied to the input data in sequence 1010, producing a sequence 1015 as output. Sequence 1015 comprises a total of 10 data values, however, two of the values are junk values (junk value 1017 and junk value 1018) that arise from the processing of junk value 1012. In a third max pooling stage, a size 2 max pooling with stride 1 kernel is applied to the input data in sequence 1015, producing a sequence 1020 as output. Sequence 1020 comprises a total of 9 data values, however, three of the values are junk values. In a fourth max pooling stage, a size 2 max pooling with stride 1 kernel is applied to the input data in sequence 1020, producing a sequence 1025 as output. Sequence 1025 comprises a total of 8 data values, however, four of the values are junk values. In a fifth max pooling stage, a size 2 max pooling with stride 6 kernel is applied to the input data in sequence 1025, producing a sequence 1030 as output. Sequence 1030 comprises 2 data values with no junk values. The stride of the size 2 max pooling with stride 6 kernel results in the size 2 max pooling with stride 6 kernel skipping over the four junk values present in sequence 1025. The size 6 max pooling with stride 6 is complete, with sequence 1030 being the output data. The size 6 max pooling with stride 6 is realized as a cascade of 4 size 2 max pooling with stride 1 stages 1035 and one size 2 max pooling with stride 6 stage 1040.

It is possible to partition and fold the cascade of size 2×2 max pooling stages onto a single hardware implementation, which makes the example embodiments particularly suitable for low small footprint, small resource devices, such as chipsets for mobile devices.

FIG. 11 illustrates a hardware implementation of a size 2×2 max pooling stage 1100. Size 2×2 max pooling stage 1100 is capable of implementing a size 2×2 max pooling stage with any stride, and may be used in the realization of a size K×K max pooling with stride S kernel as a cascade of K−1 size 2×2 max pooling stages as discussed previously. Size 2×2 max pooling stage 1100 allows for the sequential execution (with fully pipelined operation) of each pooling layer of a CNN.

Size 2×2 max pooling stage 1100 includes a data first in first out (FIFO) buffer 1105 that stores the partial results of the max pooling kernel, as well as a mask FIFO buffer 1110 that removes temporary junk values produced when the size 2×2 max pooling kernel processes data values that span adjacent windows. According to an embodiment, a size of data FIFO buffer 1105 is at least equal to the size of the intermediate output at each stage. As an example, for the first K−2 stride 1 stages, the amount of storage for each of the stages is expressible as:

(N−1), (N−2), . . . , (N−(K−2)).

While for the K−1-st stage (the stride S stage), the amount of storage for the N=K−1-st stage is expressible as:

[(N−K)/S]+1.

Therefore, the total amount of storage for data FIFO buffer 1105 is expressible as:

[(2N−K+1)(K−2)/2]+[((N−K)/S)+1].

Where K and S are the size and stride of the max pooling kernel being realized as a cascade of size 2×2 max pooling stages, and N is the input data size.

Size 2×2 max pooling stage 1100 also includes a first comparator 1115 having a first input coupled to a data input and a second input coupled to a delayed version of the data input, wherein the delayed version of the data input is provided by a delay unit 1120. First comparator 1115 is configured to compare a data input value with a delayed data input value and output the larger of the two. Size 2×2 max pooling stage 1100 also includes a second comparator 1125 having a first input coupled to an output of data FIFO buffer 1105 and a second input coupled to an output of first comparator 1115. Second comparator 1125 is configured to compare a data value from data FIFO buffer 1105 with an output of first comparator 1115 and output the larger of the two. The output of second comparator 1125 is either the output of an intermediate size 2×2 max pooling stage or the output of the size K×K max pooling with stride S kernel.

Size 2×2 max pooling stage 1100 also includes a controller 1130 coupled to data FIFO buffer 1105, and a stride value input. Controller 1115 is configured to control data FIFO buffer 1105 to store or output data values in accordance with a stride value on the stride value input. Depending on the stride value, controller 1115 uses a write control line and a read control line to have data FIFO buffer 1105 store or output data values from first comparator 1115.

Size 2 max pooling stage 1100 also includes a multiplexor 1135 having a first input coupled to an output of mask FIFO 1110, a second input coupled to the output of first comparator 1115, and a control input coupled to the output of second comparator 1125. Depending on the control input, multiplexor 1135 outputs junk values or the output of first comparator 1115.

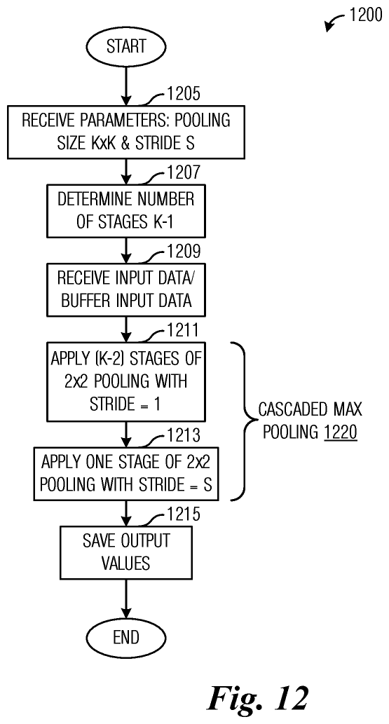

FIG. 12 illustrates a flow diagram of example operations 1200 occurring in a max pooling layer. Operations 1200 may be indicative of operations occurring in a max pooling layer of a CNN of a device realizing a size K×K max pooling with stride S kernel as a cascade of size 2×2 max pooling stages.

Operations 1200 begin with the max pooling layer of the device receiving parameters of the size K×K max pooling with stride S kernel (block 1205). The max pooling layer receives the size K and stride S values, for example. The max pooling layer determines a number of size 2×2 max pooling stages in the cascade of size 2×2 max pooling stages (block 1207). The number of size 2×2 max pooling stages in the cascade of size 2×2 max pooling stages is equal to K−1, where K−2 of the size 2×2 max pooling stages are stride 1 stages and one of the size 2×2 max pooling stages is a stride S stage.

The max pooling layer receives input data (block 1209). The max pooling layer provides the received input data to the cascade of size 2×2 max pooling stages as the input data is received, for example. The max pooling layer may provide the received input data to the cascade of size 2×2 max pooling stages once the max pooling layer has received enough input data to commence max pooling operation, for example. The max pooling layer may buffer the received input data prior to providing the input data to the cascade of size 2×2 max pooling stages, for example.

The max pooling layer applies K−2 stages of size 2×2 max pooling with stride 1 stages to the received input data (block 1211). In an embodiment, a size 2×2 max pooling stage as shown in FIG. 11 is used to implement one max pooling stage in the K−2 stages of size 2 max pooling with stride 1 layers, with output data of a first stage becoming input data of a second stage, and so on. The max pooling layer applies one stage of size 2 max pooling with stride S (block 1213). In an embodiment, a size 2×2 max pooling stage as shown in FIG. 11 is used to implement the size 2×2 max pooling with stride S stage. The output data of the K−2-th stage of the size 2×2 max pooling with stride 1 is the input data of the one stage of size 2×2 max pooling with stride S. The max pooling layer saves the output data of the size 2×2 max pooling with stride S stage (block 1215). Alternatively, the max pooling layer provides the output data of the size 2×2 max pooling with stride S stage to another layer of the CNN for additional processing. The application of the K−2 stages of size 2 max pooling with stride 1 and the one stage of size 2×2 max pooling with stride S may be collectively referred to as cascaded max pooling (blocks 1220).

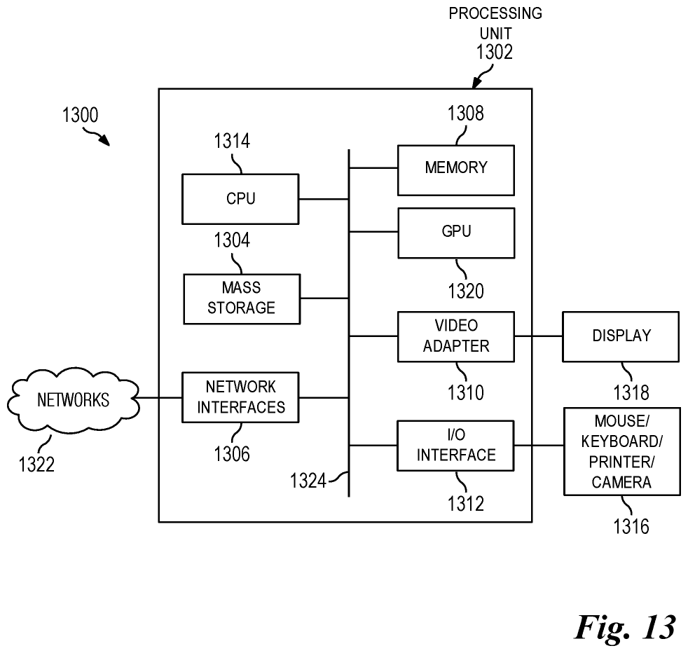

FIG. 13 is a block diagram of a computing system 1300 that may be used for implementing the devices and methods disclosed herein. For example, the computing system can be any entity of hand-held computing device, wireless handset, touchpad tablet, touchpad PC, digital camera, video camera, surveillance camera, and so on. Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 1300 includes a central processing unit (CPU) 1314, memory 1308, and may further include a mass storage device 1304, a video adapter 1310, an I/O interface 1312, and a graphics processing unit (GPU) 1320 connected to a bus 1324.

The bus 1324 may be one or more of any type of several bus architectures including a memory bus or memory controller, a peripheral bus, or a video bus. The CPU 1314 may comprise any type of electronic data processor. The memory 1308 may comprise any type of non-transitory system memory such as static random access memory (SRAM), dynamic random access memory (DRAM), synchronous DRAM (SDRAM), read-only memory (ROM), or a combination thereof. In an embodiment, the memory 1308 may include ROM for use at boot-up, and DRAM for program and data storage for use while executing programs.

The mass storage 1304 may comprise any type of non-transitory storage device configured to store data, programs, and other information and to make the data, programs, and other information accessible via the bus 1324. The mass storage 1304 may comprise, for example, one or more of a solid state drive, hard disk drive, a magnetic disk drive, or an optical disk drive.

The video adapter 1310 and the I/O interface 1312 provide interfaces to couple external input and output devices to the processing unit 1302. As illustrated, examples of input and output devices include a display 1318 coupled to the video adapter 1310 and a mouse, keyboard, printer, or camera 1316 coupled to the I/O interface 1312. Other devices may be coupled to the processing unit 1302, and additional or fewer interface cards may be utilized. For example, a serial interface such as Universal Serial Bus (USB) (not shown) may be used to provide an interface for an external device.

The GPU 1320 processes graphical data, such as images captured by the mouse, keyboard, printer, or camera 1316. The GPU 1320 makes use of computation techniques to process large amounts of data, to perform image detection, speech recognition, and so on. As an example, the GPU 1320 includes an implementation of a neural network, such as a CNN. The CNN includes a variety of processing layers, including one or more pooling layers to downsample the large amounts of data. The GPU 1320 also processes other types of data with efficient algorithms, to perform cryptocurrency mining, for example. In some embodiments, the GPU 1520 can be the device that performs dynamic max pooling.

The computing system 1500 also includes one or more network interfaces 1306, which may comprise wired links, such as an Ethernet cable, or wireless links to access nodes or different networks. The network interfaces 1306 allow the computing system 1500 to communicate with other computing systems such as servers, mobile devices, etc., via the networks. For example, the network interfaces 1306 may provide wireless communication via one or more transmitters/transmit antennas and one or more receivers/receive antennas. In an embodiment, the processing unit 1302 is coupled to a local-area network 1322 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a buffering unit or module, an applying unit or module, or an outputting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the spirit and scope of the disclosure as defined by the appended claims.

What is claimed is:

1. A computer-implemented method for performing size K×K max pooling with stride S at a pooling layer of a convolutional neural network to downsample input data, the computer-implemented method comprising:
receiving, at the max pooling layer, input data;
buffering, at the max pooling layer, the input data;
applying, at the max pooling layer, a cascade of size 2×2 pooling stages to the buffered input data to generate downsampled output data; and
outputting, from the max pooling layer, the downsampled output data to another layer of the convolutional neural network for further processing.

2. The computer-implemented method of claim 1, wherein a first subset of the size 2×2 pooling stages are with stride 1 and a second subset of the size 2×2 pooling stages are with stride S.

3. The computer-implemented method of claim 2, wherein the first subset comprises K−2 size 2×2 pooling with stride 1 stages and the second subset comprises one dimension 2 with stride S pooling stage.

4. The computer-implemented method of claim 2, wherein applying the cascade of size 2×2 pooling stages comprises:
applying, at the max pooling layer, a cascade of K−2 size 2×2 pooling with stride 1 stages to the buffered input data to generate intermediate output data; and
applying, at the max pooling layer, a size 2×2 pooling with stride S stage to the intermediate output data to generate the downsampled output data.

5. The computer-implemented method of claim 4, wherein the cascade of K−2 size 2×2 pooling with stride 1 stages is applied to the buffered input data prior to the applying of the size 2×2 pooling with stride S stage.

6. The computer-implemented method of claim 1, wherein the cascade of size 2×2 pooling stages comprises a linear sequence of size 2×2 pooling stages.

7. The computer-implemented method of claim 1, wherein the convolutional neural network is part of a graphics processing unit (GPU).

8. A processing unit comprising:
a first comparator operatively coupled to a data input and a delayed data input, the first comparator configured to output a greater of the data input or the delayed data input;
a data buffer operatively coupled to an output line of the first comparator and a stride input, the data buffer configured to store an output of the first comparator;
a second comparator operatively coupled to an output line of the data buffer and the output line of the first comparator, the second comparator configured to output a greater of the output of the first comparator or an output of the data buffer;
a mask buffer operatively coupled to the output line of the first comparator, the mask buffer configured to remove unwanted values;
a multiplexer operatively coupled to the output line of the mask buffer, to the output line of the first comparator, and to an output line of the second comparator, the multiplexer configured to select between an output of the mask buffer or the output of the first comparator in accordance with an output of the second comparator; and
a controller in communication with the data buffer, the controller configured to receive a stride value, control the data buffer to buffer the output of the first comparator in accordance with the stride value, and output the buffered output of the first comparator in accordance with the stride value.

9. The processing unit of claim 8, further comprising a delay element operatively coupled to the data input and the first comparator, the delay element configured to output the delayed data input.

10. The processing unit of claim 8, wherein the first comparator and the second comparators are two-input and one-output comparators.

11. The processing unit of claim 8, wherein the processing unit realizes a size K×K max pooling with stride S kernel as a cascade of K−1 size 2×2 max pooling stages, and wherein a size of the data buffer is expressible as
[(2N−K+1)(K−2)/2]+[((N−K)/S)+1],
where K is a size of the size K×K max pooling with stride S kernel in either dimension, S is a stride of the size K×K max pooling with stride S kernel, and N is a size of the input data.

12. The processing unit of claim 8, wherein the processing unit is a size 2×2 max pooling unit.

13. The processing unit of claim 12, wherein the processing unit implements a max pooling layer in a convolutional neural network (CNN).

14. A device comprising:
a central processing unit configured to execute instructions stored in a memory storage; and
a processing unit operatively coupled to the central processing unit, the memory storage, and a data input, the processing unit configured to perform size K×K max pooling with stride S at a max pooling layer of a convolutional neural network to downsample input data received at the data input, wherein the processing unit performs the size K×K max pooling with stride S as a cascade of K−1 size 2×2 max pooling stages, where K and S are integer values.

15. The device of claim 14, wherein the processing unit comprises:
a first comparator operatively coupled to a data input and a delayed data input, the first comparator configured to output a greater of the data input or the delayed data input;
a data buffer operatively coupled to an output line of the first comparator and a stride input, the data buffer configured to store an output of the first comparator;
a second comparator operatively coupled to an output line of the data buffer and the output line of the first comparator, the second comparator configured to output a greater of the output of the first comparator or an output of the data buffer;
a mask buffer operatively coupled to the output line of the first comparator, the mask buffer configured to remove unwanted values;
a multiplexer operatively coupled to the output line of the mask buffer, to the output line of the first comparator, and to an output line of the second comparator, the multiplexer configured to select between an output of the mask buffer or the output of the first comparator in accordance with an output of the second comparator; and
a controller in communication with the data buffer, the controller configured to receive a stride value, control the data buffer to buffer the output of the first comparator in accordance with the stride value, and output the buffered output of the first comparator in accordance with the stride value.

16. The device of claim 15, wherein the processing unit further comprises a delay element operatively coupled to the data input and the first comparator, the delay element configured to output the delayed data input.

17. The device of claim 15, wherein the first comparator and the second comparators are two-input and one-output comparators.

18. The device of claim 15, wherein a size of the data buffer is expressible as
[(2N−K+1)(K−2)/2]+[((N−K)/S)+1],
where K is a size of the size K×K max pooling with stride S kernel in either dimension, S is a stride of the size K×K max pooling with stride S kernel, and N is a size of the input data.

19. The device of claim 14, wherein the data input is operatively coupled to a digital camera.

20. The device of claim 14, wherein the device is a user equipment (UE).
